(19) United States
(12) Patent Application Publication
(10) Pub. No.: US 2018/0165838 A1
(43) Pub. Date: Jun. 14, 2018

(54) SYSTEM AND METHOD FOR GENERATING A SEMANTICALLY MEANINGFUL TWO-DIMENSIONAL IMAGE FROM THREE-DIMENSIONAL DATA

(71) Applicant: Faraday&Future Inc., Gardena, CA (US)

(72) Inventors: Veera Ganesh Ganesh, Sunnyvale, CA (US); Jan Becker, Palo Alto, CA (US)

(21) Appl. No.: 15/662,638

(22) Filed: Jul. 28, 2017

Related U.S. Application Data
(60) Provisional application No. 62/368,529, filed on Jul. 29, 2016.

(51) Int. Cl. G06T 11/00; G06T 15/20; G08G 1/16

(52) U.S. Cl. CPC G06T 11/001; G06T 2210/21; G08G 1/16; G06T 15/205

(57) ABSTRACT

A system and method for detecting, with a fully or partially autonomous vehicle, a nearby object and generating a two-dimensional image representing the object is described. The vehicle can identify the nearby object using one or more included sensors and/or data from one or more high-definition (HD) maps stored in a memory device included in the vehicle, for example. In some examples, the visual representation can be colorized according to a type or other characteristic of the object. The visual representation can be displayed at a display included in the vehicle to alert a passenger of the object's presence in poor visibility conditions where the passengers may otherwise be unaware of the object.

### CROSS-REFERENCE TO RELATED APPLICATIONS

This application claims the benefit of U.S. Provisional Application No. 62/368,529, filed Jul. 29, 2016, the entirety of which is hereby incorporated by reference.

### FIELD OF THE DISCLOSURE

This relates to a vehicle, and more particularly to a vehicle configured to generate a semantically meaningful two-dimensional representation of three-dimensional data.

### BACKGROUND OF THE DISCLOSURE

Fully or partially autonomous vehicles, such as autonomous consumer automobiles, offer convenience and comfort to passengers. In some examples, an autonomous vehicle can rely on data from one or more on-board sensors to safely and smoothly navigate in normal traffic conditions. Autonomous vehicles can follow a route to navigate from one location to another, obey traffic rules (e.g., obey stop signs, traffic lights, and speed limits), and avoid collisions with nearby objects (e.g., other vehicles, people, animals, debris, etc.). In some examples, autonomous vehicles can perform these and additional functions in poor visibility conditions, relying on data from HD maps and proximity sensors (e.g., LiDAR, RADAR, and/or ultrasonic sensors) to safely navigate and maneuver.

### SUMMARY OF THE DISCLOSURE

This relates to a vehicle, and more particularly to a vehicle configured to generate a semantically meaningful two-dimensional (2D) representation of three-dimensional (3D) data. In some examples, a vehicle can detect a nearby object using one or more sensors such as cameras and/or proximity sensors (e.g., LiDAR, RADAR, and/or ultrasonic sensors). A vehicle can further characterize the nearby object based on detected 3D data and/or information from a HD map stored at a memory of the vehicle, for example. In some examples, a first vehicle can wirelessly notify a second vehicle of a nearby object and transmit one or more of 3D data, an object characterization, a 2D grayscale image, and a 2D color image to the second vehicle wirelessly. A processor included in the vehicle can generate a colorized 2D image from the collected data to alert a passenger of a nearby object, so that the passenger can understand autonomous vehicle behavior such as slowing down, stopping, and/or turning in poor visibility conditions when the passenger may be unable to see the object.

### BRIEF DESCRIPTION OF THE DRAWINGS

FIG. 1A illustrates an exemplary autonomous vehicle in proximity to a non-static object according to examples of the disclosure.

FIG. 1B illustrates an interior view of an exemplary vehicle including a representation of a non-static object according to examples of the disclosure.

FIG. 1C illustrates an interior view of an exemplary vehicle including a representation of a non-static object according to examples of the disclosure.

FIG. 1D illustrates an exemplary process for generating a visual representation of a non-static object according to examples of the disclosure.

FIG. 2A illustrates an exemplary autonomous vehicle in proximity to a static object according to examples of the disclosure.

FIG. 2B illustrates an interior view of an exemplary vehicle including a representation of a static object according to examples of the disclosure.

FIG. 2C illustrates an exemplary interior view of vehicle including a representation of a static object according to examples of the disclosure.

FIG. 2D illustrates an exemplary process for generating a visual representation of a static object according to examples of the disclosure.

FIG. 3A illustrates an exemplary vehicle in proximity to a second vehicle and a pedestrian according to examples of the disclosure.

FIG. 3B illustrates an interior view of an exemplary vehicle including a representation of a static object according to examples of the disclosure.

FIG. 3C illustrates an interior view of an exemplary vehicle including a representation of a pedestrian detected by a second vehicle according to examples of the disclosure.

FIG. 3D illustrates an exemplary process for generating a visual representation of a pedestrian detected by a second vehicle according to examples of the disclosure.

FIG. 4 illustrates an exemplary process for notifying a nearby vehicle of a proximate object according to examples of the disclosure.

FIG. 5 illustrates a block diagram of an exemplary vehicle according to examples of the disclosure.

### DETAILED DESCRIPTION

In the following description, reference is made to the accompanying drawings which form a part hereof, and in which it is shown by way of illustration specific examples that can be practiced. It is to be understood that other examples can be used and structural changes can be made without departing from the scope of the examples of the disclosure.

Fully or partially autonomous vehicles, such as autonomous consumer automobiles, offer convenience and comfort to passengers. In some examples, an autonomous vehicle can rely on data from one or more on-board sensors to safely and smoothly navigate in normal traffic conditions. Autonomous vehicles can follow a route to navigate from one location to another, obey traffic rules (e.g., obey stop signs, traffic lights, and speed limits), and avoid collisions with nearby objects (e.g., other vehicles, people, animals, debris, etc.). In some examples, autonomous vehicles can perform these and additional functions in poor visibility conditions, relying on data from HD maps and proximity sensors (e.g., LiDAR, RADAR, and/or ultrasonic sensors) to safely navigate and maneuver.

This relates to a vehicle, and more particularly to a vehicle configured to generate a semantically meaningful two-dimensional (2D) representation of three-dimensional (3D) data. In some examples, a vehicle can detect a nearby object using one or more sensors such as cameras and/or proximity sensors (e.g., LiDAR, RADAR, and/or ultrasonic sensors). A vehicle can further characterize the nearby object based on detected 3D data and/or information from a HD map stored at a memory of the vehicle, for example. In some examples, a first vehicle can wirelessly notify a second vehicle of a nearby object and transmit one or more of 3D data, an object characterization, a 2D grayscale image, and a 2D color image to the second vehicle wirelessly. A processor included in the vehicle can generate a colorized 2D image from the collected data to alert a passenger of a nearby object, so that the passenger can understand autonomous vehicle behavior such as slowing down, stopping, and/or turning in poor visibility conditions when the passenger may be unable to see the object.

Fully or partially autonomous vehicles can rely on navigation maps, HD maps, and one or more on-vehicle sensors to safely navigate and maneuver to a selected location. In some examples, an autonomous vehicle can plan a route in advance by downloading navigation information from the internet. The vehicle can monitor its location while driving using GPS, for example. To safely maneuver the vehicle while driving, the vehicle can rely on one or more sensors, such as one or more cameras, LiDAR devices, and ultrasonic sensors, for example. In some examples, the vehicle can use one or more HD maps to resolve its location more accurately than possible with GPS. HD maps can include a plurality of features such as buildings, street signs, and other landmarks and their associated locations, for example. In some examples, the vehicle can identify one or more of these static objects using its sensors and match them to one or more HD map features to verify and fine-tune its determined location. The one or more sensors can also detect non-static objects not included in the HD map such as pedestrians, other vehicles, debris, and animals, for example. The vehicle can autonomously maneuver itself to avoid collisions with static and non-static objects by turning, slowing down, and stopping, for example. Herein, the terms autonomous and partially autonomous may be used interchangeably. For example, in some examples a vehicle may be described as driving in an autonomous mode. In such an example, it should be appreciated that the reference to an autonomous mode may include both partially autonomous and fully autonomous (e.g., any autonomy level).

In some examples, an autonomous vehicle can function in situations where a human driver may have trouble safely operating the vehicle, such as during poor visibility conditions (e.g., at night, in fog, etc.). An autonomous vehicle can drive normally when visibility is poor by relying on LiDAR and other non-optical sensors to locate nearby objects, including static and non-static objects, for example. When driving autonomously in these situations, however, a user may not understand vehicle behavior because they cannot see their surroundings. For example, the vehicle may apply the brakes in response to an obstacle or stop sign that it can detect with LiDAR or another non-optical sensor. Because of the poor visibility, a passenger in the vehicle may not see the obstacle or traffic light and not understand the vehicle's response. The passenger may be confused or may assume the system is not working properly and try to intervene when it is unsafe to do so, for example. Accordingly, it can be advantageous for the vehicle to characterize nearby objects and alert the passengers of the object's type and presence with a semantically meaningful two-dimensional (2D) color image representing the object.

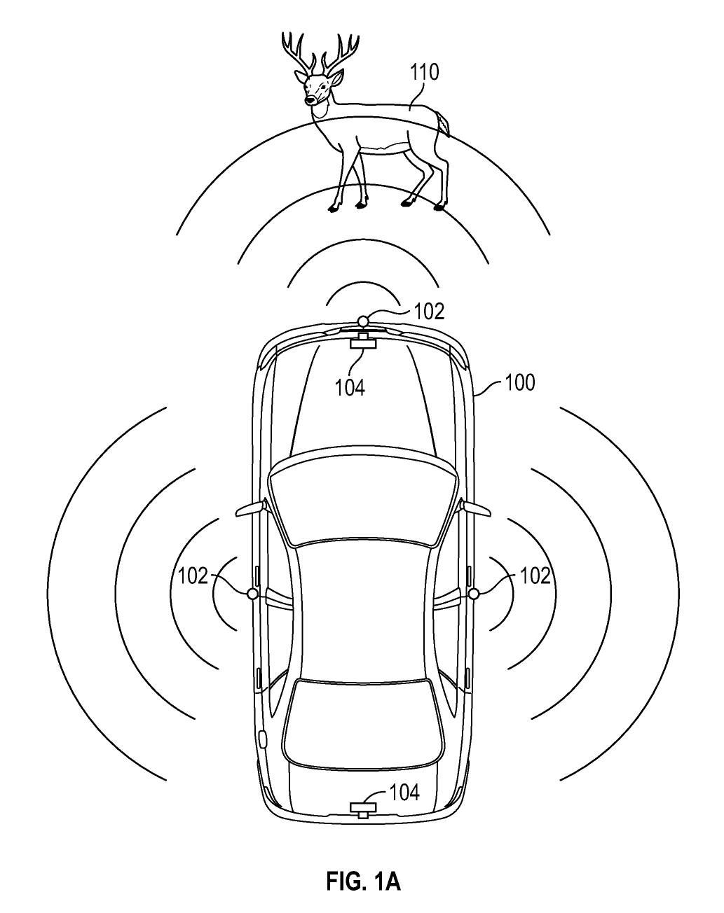

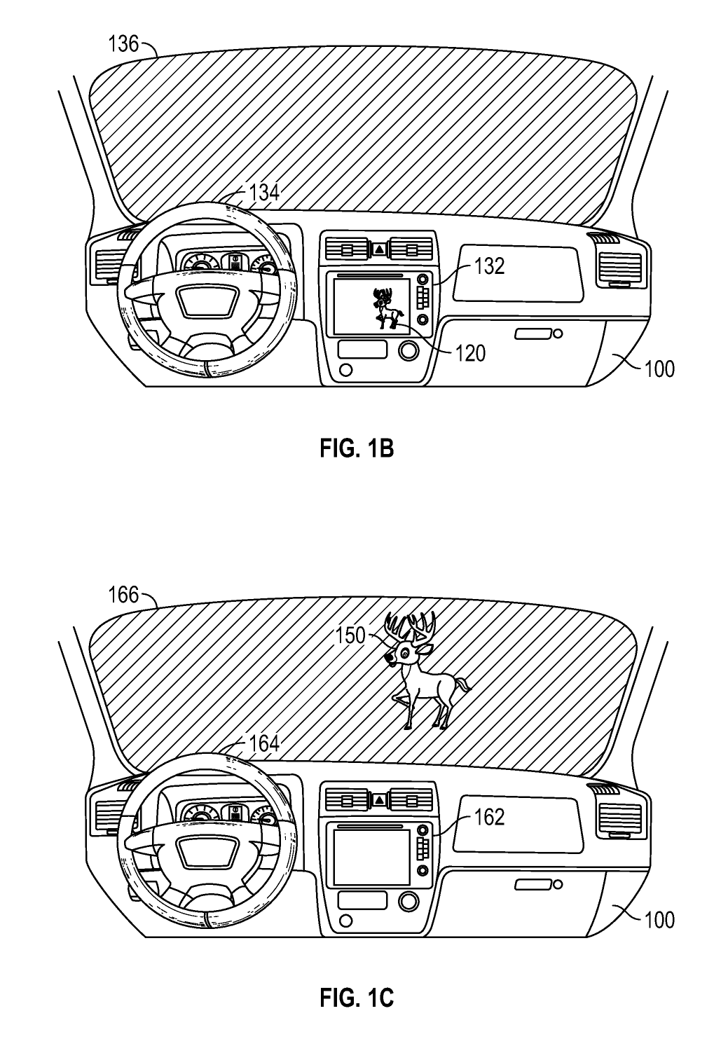

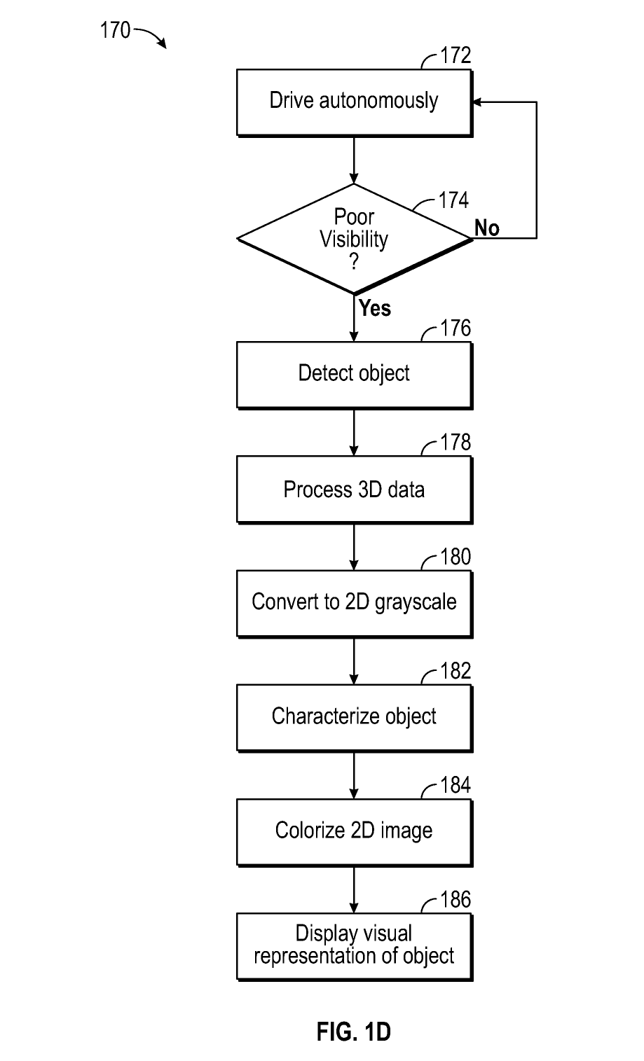

FIG. 1A illustrates an exemplary autonomous vehicle 100 in proximity to a non-static object according to examples of the disclosure. Vehicle 100 can include a plurality of sensors, such as proximity sensors 102 (e.g., LiDAR, ultrasonic sensors, RADAR, etc.) and cameras 104. Vehicle 100 can further include an onboard computer (not shown), including one or more processors, controllers, and memory, for example.

While driving autonomously, vehicle 100 can encounter a non-static object (i.e. an object not included in an HD map), such as an animal 110. One or more sensors, such as proximity sensor 102 or camera 104 can detect the animal 110, for example. In some examples, in response to detecting the animal 110, the vehicle 100 can perform a maneuver (e.g., slow down, stop, turn, etc.) to avoid a collision. If visibility conditions are poor, a proximity sensor 102, which can generate non-visual three-dimensional (3D) data, can detect the animal 110 without the camera 104, for example. For example, the one or more sensors 102 can detect a 3D shape of the animal 110 absent any visual input. However, a passenger in vehicle 100 may not be able to see the animal 110. To enhance human-machine interaction, vehicle 100 can notify the passenger that the animal 110 is close to the vehicle 100, as will be described.

FIG. 1B illustrates an interior view of exemplary vehicle 100 including a representation 120 of a non-static object according to examples of the disclosure. Vehicle 100 can further include an infotainment panel 132 (e.g., an infotainment display), steering wheel 134, and front windshield 136. In response to detecting an animal 110 using one or more proximity sensors 102, vehicle 100 can generate a visual representation 120 to alert the passengers that the animal 110 is close to the vehicle 100.

Vehicle 100 can generate the visual representation 120 of the animal 110 based on non-visual 3D data from the one or more proximity sensors 102. For example, an outline of the animal 110 can be determined from the 3D data and can optionally be matched to a database of object types and their corresponding shapes. More details on how the visual representation 120 can be produced will be described. In some examples, the visual representation 120 can be displayed on infotainment panel 132 and can be rendered in color. The visual representation 120 can be colored realistically, rendered in a single color indicative of the object type (e.g., non-static, animal, etc.), or rendered with a gradient indicative of distance between the animal 110 and the vehicle 100, for example. In some examples, a position of visual representation 120 can be indicative of a position of the animal 110 relative to the vehicle 100. For example, when the animal 110 is towards the right of the vehicle 100, visual representation 120 can be displayed in a right half of display 132. In some examples, the position of visual representation 120 can be independent of the position of the animal 110.

FIG. 1C illustrates an exemplary interior view of vehicle 100 including a representation 150 of a non-static object, according to examples of the disclosure. Vehicle 100 can further include an infotainment panel 162, steering wheel 164, and front windshield 166. In response to detecting animal 110 using one or more proximity sensors 102, vehicle 100 can generate a visual representation 150 to alert the passengers that animal 110 is close to the vehicle 100.

Vehicle 100 can generate the visual representation 150 based on 3D data from the one or more proximity sensors 102. For example, an outline of animal the 110 can be determined from the non-visual 3D data and can optionally be matched to a database of object types and their corresponding shapes. More details on how the visual representation 150 can be produced will be described. In some examples, the visual representation 160 can be displayed on a heads-up display (HUD) included in the windshield 166 and can be rendered in color. The visual representation 120 can be colored realistically, rendered in a single color indicative of the object type (e.g., nonstatic, animal, etc.), or rendered with a gradient indicative of a distance between the animal 110 and the vehicle 100, for example. In some examples, a position of visual representation 150 can be indicative of a position of the animal 110 relative to the vehicle 100. For example, when the animal 110 is towards the right of the vehicle 100, visual representation 120 can be displayed in a right half HUD included in windshield 166. In some examples, the position of visual representation 150 can be independent of the position of the animal 110.

In some examples, visual representation 120 can be displayed on infotainment panel 132 or 162 at a same time that visual representation 160 is displayed on a HUD included in windshield 136 or 166. In some examples, a user can select where they would like visual indications, including visual representations 120 or 150, to be displayed. In some examples, a sound can be played or a tactile notification can be sent to the passengers while visual representation 120 or 150 is displayed to further alert the passengers. In some examples, text can be displayed with the visual representation 120 or 150 to identify the type of object (e.g., “animal detected”), describe the maneuver the vehicle is performing (e.g., “automatic deceleration”), and/or display other information (e.g., a distance between the vehicle 100 and the animal 110). In some examples, in response to detecting two or more objects, the vehicle can display two or more visual representations of the detected objects at the same time.

FIG. 1D illustrates an exemplary process 170 for generating a visual representation of a non-static object according to examples of the disclosure. Process 170 can be performed by the vehicle 100 when it encounters the animal 110 or any other non-static object not included in one or more HD maps accessible to vehicle 100 while driving autonomously, for example.

Vehicle 100 can drive autonomously using one or more sensors such as proximity sensor 102 and/or camera 104 to detect the surroundings of vehicle 100, for example (step 172 of process 170). In some examples, vehicle 100 can use data from one or more HD maps to fine-tune its determined location and identify nearby objects, such as street signs, traffic signs and signals, buildings, and/or other landmarks.

While driving autonomously, vehicle 100 can detect poor visibility conditions (e.g., low light, heavy fog, etc.) (step 174 of process 170). Vehicle 100 can detect poor visibility conditions 174 based on one or more images captured by cameras 104, a level of light detected by an ambient light sensor (not shown) of vehicle 100, or the output of one or more other sensors included in vehicle 100. In some examples, a passenger in vehicle 100 can input a command (e.g., via a voice command, via a button or switch, etc.) to vehicle 100 indicating that visibility is poor. In response to the determined poor visibility conditions or user input, vehicle 100 can provide visual information to one or more passengers, for example.

Vehicle 100 can detect an object (e.g., animal 110) (step 176 of process 170) while autonomously driving during poor visibility conditions. In some examples, an object can be detected 176 using proximity sensors 102 of vehicle 100. Detecting the object can include collecting non-visual 3D data corresponding to the object. In some examples, the non-visual 3D data can be a plurality of 3D points in space corresponding to where the object is located.

In some examples, the non-visual 3D data can be processed to determine a 3D shape, size, speed, and/or location of a detected object (step 178 of process 170). Processing non-visual 3D data can include determining whether vehicle 100 will need to perform a maneuver (e.g., slow down, stop, turn, etc.) to avoid the detected object, for example. If, for example, the detected object is another vehicle moving at a same or a faster speed than vehicle 100, vehicle 100 may not need to adjust its behavior. If the object requires vehicle 100 to perform a maneuver or otherwise change its behavior, method 170 can continue.

Based on the processed 3D data, vehicle 100 can generate a grayscale 2D image of the detected object (step 180 of process 170). In some examples, generating a 2D image 180 includes determining an outline of the detected object. Vehicle 100 can also identify features of the object based on the 3D data to be rendered (e.g., facial features of animal 110).

Vehicle 100 can further characterize the detected object (step 182 of process 170). Object characterization can be based on the 3D data and/or the 2D outline of the object. In some examples, a memory device included in the vehicle 100 can include object shape data with associated characterization data stored thereon. For example, memory of a vehicle 100 can store a lookup table of 3D shapes and/or 2D outlines and the corresponding object types for each.

In some examples, rather than first determining a 2D grayscale image and then characterizing the object, vehicle 100 can first characterize the object from the 3D data. Then, vehicle 100 can produce the 2D image based on the object characterization and the 3D data.

In some examples, the characterized 2D grayscale image can be colorized (step 184 of process 170). In some examples, the 2D image can be colorized to have realistic colors based on the characterization of the detected object. Realistic colorization can be determined based on stored color images associated with the object type and its size, shape, or other characteristics. In some examples, the 2D image can be colorized according to what type of object it is. For example, animals can be rendered in a first color, while traffic signs can be rendered in a second color. In some examples, colorization can vary depending on a distance of the detected object from the vehicle 100 (e.g., colors can become lighter, darker, brighter, or change colors based on distance).

Once rendered in 2D, characterized, and colorized, the visual representation of the detected object can be displayed on one or more screens included in vehicle 100 (step 186 of process 170). For example, visual representation 120 can be displayed on an infotainment panel 132 and visual representation 150 can be displayed on a HUD included in windshield 166. In some examples, a vehicle can include additional or alternative screens configured to display a visual representation of a nearby object. In some examples, vehicle 100 can produce a second notification, such as a sound or a tactile notification, in addition to displaying the visual representation 120 or 150.

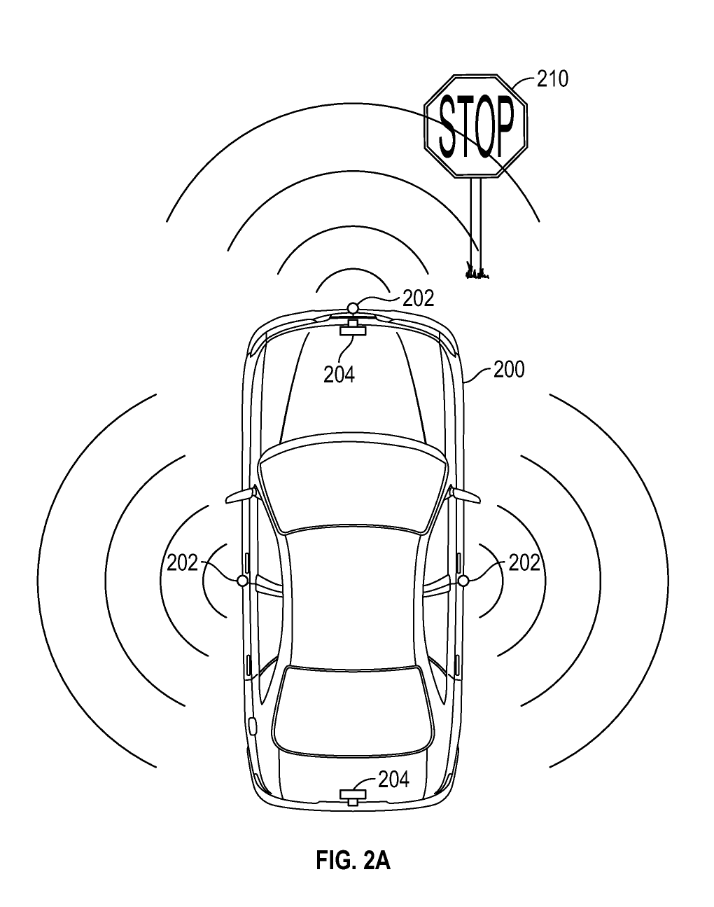

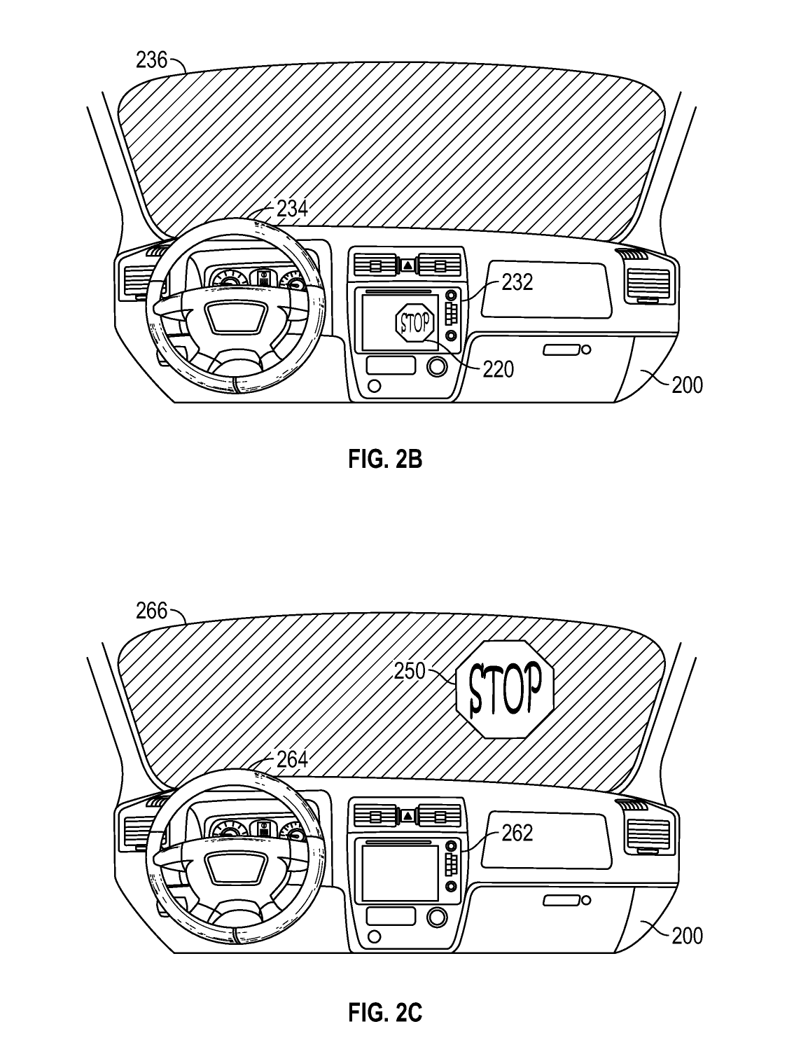

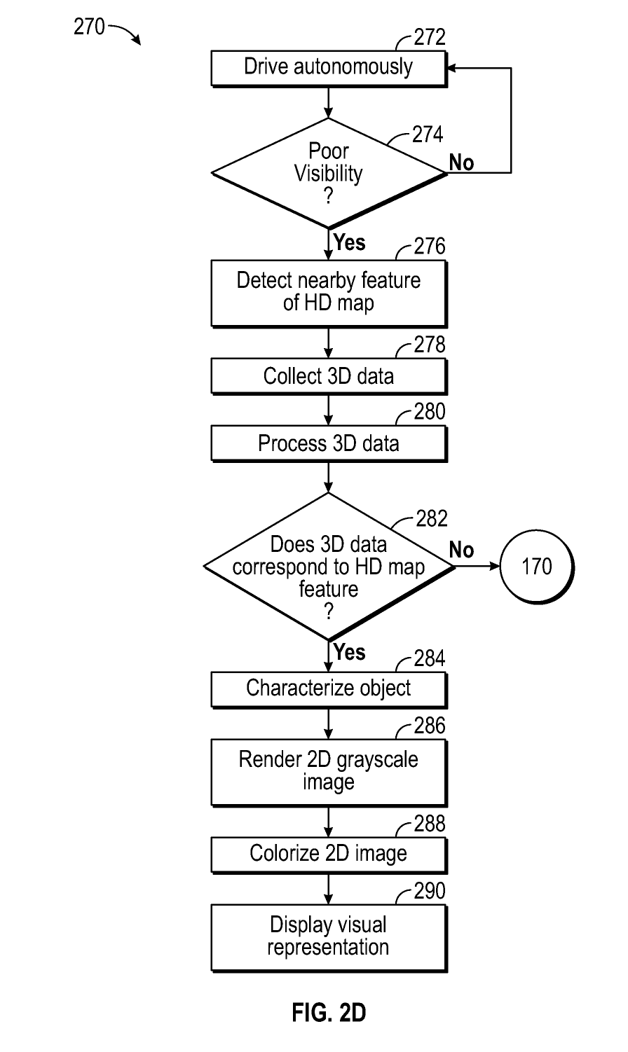

FIG. 2A illustrates an exemplary autonomous vehicle 200 in proximity to a static object according to examples of the disclosure. Vehicle 200 can include a plurality of sensors, such as proximity sensors 202 (e.g., LiDAR, ultrasonic sensors, RADAR, etc.) and cameras 204. Vehicle 200 can further include an onboard computer (not shown), including one or more processors, controllers, and memory, for example. In some examples, memory can have one or more HD maps including a plurality of features, such as stop sign 210, stored thereon.

While driving autonomously, vehicle 200 can encounter a static object (i.e. an object included in an HD map), such as stop sign 210, for example. In some examples, vehicle 200 can use the one or more HD maps to predict that it will encounter the stop sign 210. Additionally, one or more sensors, such as proximity sensor 202 or camera 204 can detect the stop sign 210, for example. In response to detecting stop sign 210, vehicle 200 can autonomously stop, for example. If visibility conditions are poor, a proximity sensor 202, which can generate non-visual 3D data, can detect the stop sign 210 without the one or more cameras 204 and/or the stop sign 210 can be matched to a feature included in one or more HD maps. For example, the one or more sensors 202 can detect a 3D shape of the stop sign 210 absent any visual input. However, a passenger in vehicle 200 may not be able to see the stop sign 210. To enhance human-machine interaction, vehicle 200 can notify the passenger that stop sign 210 is close to the vehicle 200, as will be described.

FIG. 2B illustrates an interior view of exemplary vehicle 200 including a representation 220 of a static object according to examples of the disclosure. Vehicle 200 can further include an infotainment panel 232 (e.g., an infotainment display), steering wheel 234, and front windshield 236. In response to detecting the stop sign 210 using one or more proximity sensors 202, vehicle 200 can generate a visual representation 220 to alert the passengers that the stop sign 210 is close to the vehicle 200.

Vehicle 200 can generate the visual representation 220 based on non-visual 3D data from the one or more proximity sensors 202 and/or feature data from one or more HD maps. For example, an outline of the stop sign 210 can be determined from the 3D data and can optionally be matched to a database of object types and their corresponding shapes. In some examples, an object type can be determined from HD map data. More details on how the visual representation 220 can be produced will be described. In some examples, the visual representation 220 can be displayed on infotainment panel 232 and can be rendered in color. The visual representation 220 can be colored realistically, rendered in a single color indicative of the object type (e.g., static, stop sign, etc.), or rendered with a gradient indicative of object distance, for example. In some examples, a position of visual representation 220 can be indicative of a position of the stop sign 210 relative to the vehicle 200. For example, when the stop sign 210 is towards the right of the vehicle 200, visual representation 220 can be displayed in a right half of display 232. In some examples, the position of visual representation 220 can be independent of the position of the stop sign 210.

FIG. 2C illustrates an interior view of exemplary vehicle 200 including a representation 250 of a static object according to examples of the disclosure. Vehicle 200 can further include an infotainment panel 262, steering wheel 264, and front windshield 266. In response to detecting stop sign 210 using one or more proximity sensors 202, vehicle 200 can generate a visual representation 250 to alert the passengers that stop sign 210 is close to the vehicle 200.

Vehicle 200 can generate the visual representation 250 based on 3D data from the one or more proximity sensors 202 and/or feature data from one or more HD maps. For example, an outline of stop sign 210 can be determined from the non-visual 3D data and can optionally be matched to a database of objects types and their corresponding shapes. Further, in some examples, the characters on a sign (e.g., the word stop on a stop sign 210, numbers on a speed limit sign, etc.) can be determined using LiDAR sensors. In some examples, object type can be determined from HD map data. More details on how the visual representation 250 can be produced will be described. In some examples, the visual representation 250 can be displayed on heads-up display included in windshield 266 and can be rendered in color. The visual representation 250 can be colored realistically, rendered in a single color indicative of the object type (e.g., static, stop sign, etc.), or rendered with a gradient indicative of object distance, for example. In some examples, a position of visual representation 250 can be indicative of a position of the stop sign 210 relative to the vehicle 200. For example, when the stop sign 210 is towards the right of the vehicle 200, visual representation 220 can be displayed in a right half HUD included in windshield 266. In some examples, the position of visual representation 250 can be independent of the position of the animal 210.

In some examples, visual representation 220 can be displayed on infotainment panel 232 or 262 at a same time that visual representation 260 is displayed on a HUD included in windshield 236 or 266. In some examples, a user can select where they would like visual indications, including visual representations 220 or 250, to be displayed. A sound can be played or a tactile notification can be sent to the passengers while visual representation 220 or 250 is displayed to further alert the passengers, for example. In some examples, text can be displayed with the visual representation 220 or 250 to identify the type of object (e.g., “stop sign detected”), describe the maneuver the vehicle is performing (e.g., “automatic braking”), and/or display other information (e.g., a distance between vehicle 200 and the stop sign 210). In some examples, in response to detecting two or more objects, the vehicle can display two or more visual representations of the detected objects at the same time.

FIG. 2D illustrates an exemplary process 270 for generating a visual representation of a static object according to examples of the disclosure. Process 270 can be performed by autonomous vehicle 200 in response to detecting stop sign 210 or any other static object corresponding to a feature included in one or more HD maps accessible to vehicle 200.

Vehicle 200 can drive autonomously using one or more sensors such as proximity sensor 202 and/or camera 204 to detect the surroundings of vehicle 200, for example (step 272 of process 270). In some examples, vehicle 200 can use data from one or more HD maps to fine-tune its determined location and identify nearby objects, such as street signs, traffic signs and signals, buildings, and/or other landmarks.

While driving autonomously, vehicle 200 can detect poor visibility conditions (step 274 of process 270). Vehicle 200 can detect poor visibility conditions 274 based on one or more images captured by cameras 204, a level of light detected by an ambient light sensor (not shown) of vehicle 200, and/or the output of one or more other sensors included in vehicle 200. In some examples, a passenger in vehicle 200 can input a command (e.g., a voice command, via a button or switch, etc.) to vehicle 200 indicating that visibility is poor. In response to the determined poor visibility conditions or user input, vehicle 200 can provide visual data to its one or more passengers.

Vehicle 200 can detect an object (e.g., stop sign 210) corresponding to a feature of one or more HD maps (step 276 of process 170) while autonomously driving in poor visibility conditions. In some examples, an object can be detected 276 using proximity sensors 202 of vehicle 200. When a size, location, or other characteristic of the detected object corresponds to a feature of one or more HD maps, vehicle 200 can associate the detected object with the corresponding feature.

Detecting the object can include collecting 3D data corresponding to the object, for example (step 278 of process 270). Collecting non-visual 3D data can, for example, better resolve object size, shape, and/or location and verify that the object corresponds to the feature of the one or more HD maps.

In some examples, vehicle 200 can determine whether the 3D data correspond to the feature of the one or more HD maps (step 282 of process 270). The determination can include processing the non-visual 3D data to determine a 3D shape, size, speed, and location of a detected object. Based on a determination that the 3D data do not correspond to a feature of one or more HD maps, method 170, described with reference to FIG. 1D, can be used to characterize a non-static object. Based on a determination that the 3D data correspond to the feature of the one or more HD maps, process 270 can continue.

In some examples, processing non-visual 3D data can include determining whether vehicle 200 will need to perform a maneuver (e.g., slow down, stop, turn, etc.) to avoid the detected object. If, for example, the detected object is another vehicle moving at a same or a faster speed than vehicle 200, vehicle 200 may not need to adjust its behavior. If the object requires vehicle 200 to perform a maneuver or otherwise change its behavior, the method 270 can continue.

Based on a determination that the detected object corresponds to a feature of one or more HD maps, vehicle 200 can characterize the object (step 284 of process 270). For example, an HD map can include characterization data for the feature.

In some examples, vehicle 200 can generate a grayscale 2D image of the detected object based on the collected non-visual 3D data and data from one or more HD maps (step 286 of process 270). In some examples, generating a 2D image 286 includes determining an outline of the detected object. Determining an outline of the detected object can be based on the non-visual 3D data and/or data provided by the one or more HD maps. Vehicle 200 can also identify features of the object based on the 3D data to be rendered. In some examples, one or more HD maps can provide a grayscale 2D image of the feature corresponding to the detected object.

Vehicle 200 can colorize the characterized 2D grayscale image, for example (step 288 of process 270). In some examples, the 2D image can be colorized to have realistic colors based on the characterization of the detected object. Realistic colorization can be determined based on stored color images associated with the type and size, shape, classification, or other characteristics of the detected object. In some examples, the 2D image can be colorized according to a type of the object. For example, animals can be rendered in a first color, while traffic signs can be rendered in a second color. In some examples, colorization can vary depending on a distance of the detect object (e.g., colors can become lighter, darker, brighter, or change colors based on distance). In some examples, one or more HD maps can provide a colorized 2D image of the feature corresponding to the detected object.

Once rendered in 2D, characterized, and colorized, the visual representation of the detected object can be displayed on one or more screens included in vehicle 200 (step 290 of process 270). For example, visual representation 220 can be displayed on an infotainment panel 232 and visual representation 250 can be displayed on a HUD included in windshield 266. In some examples, a vehicle can include additional or alternative displays configured to display a visual representation of a nearby object. In some examples, vehicle 200 can produce a second notification, such as a sound or a tactile notification, in addition to displaying the visual representation 220 or 250.

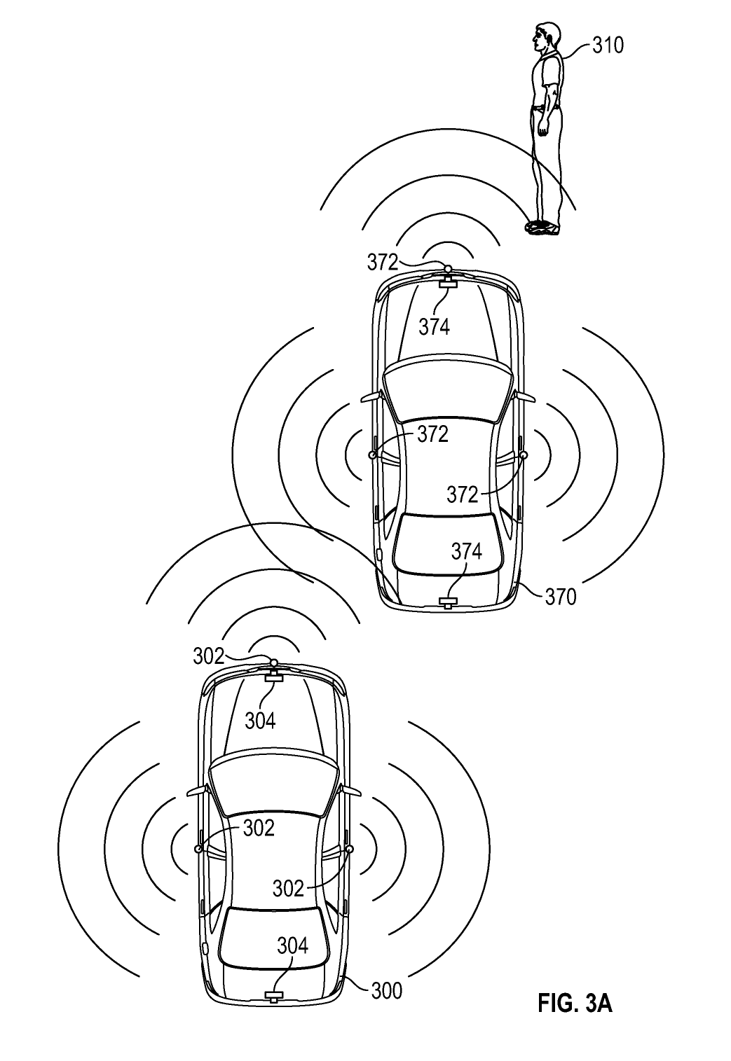

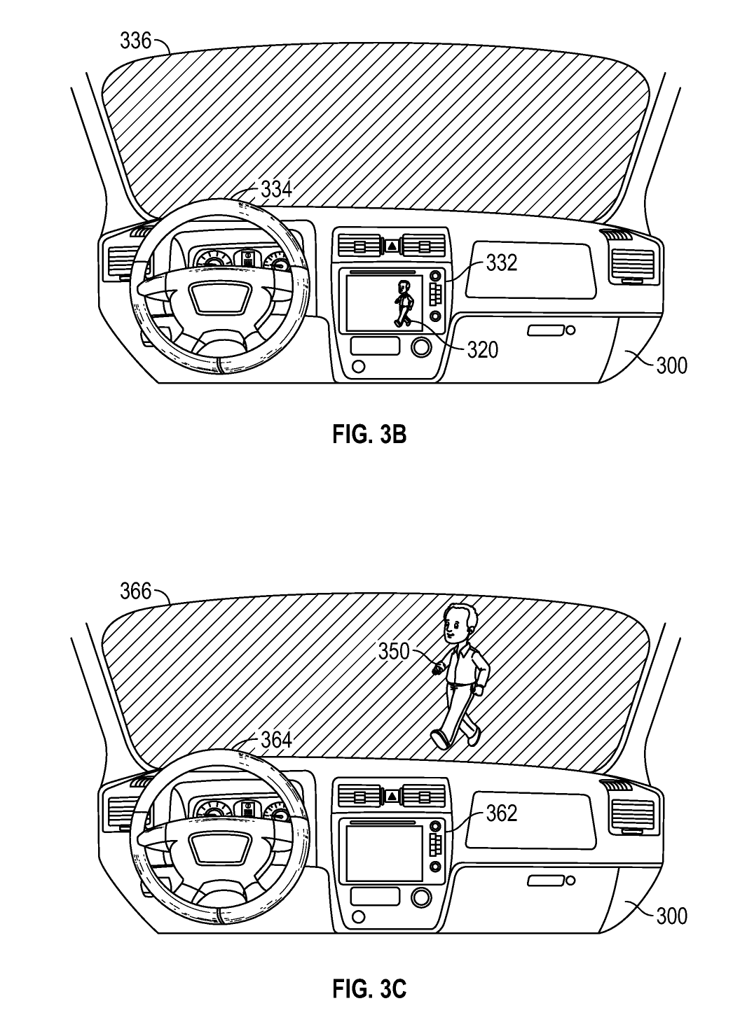

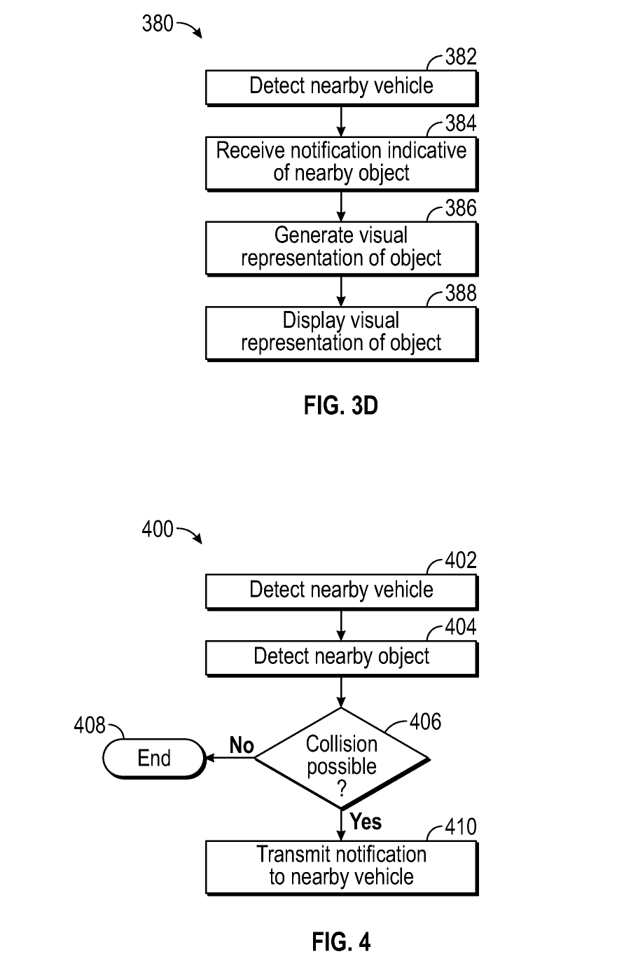

FIG. 3A illustrates an exemplary autonomous vehicle 300 in proximity to a second vehicle 370 and a pedestrian 310 according to examples of the disclosure. Vehicle 300 can include a plurality of sensors, such as proximity sensors 302 (e.g., LiDAR, ultrasonic sensors, RADAR, etc.) and cameras 304. Vehicle 300 can further include an onboard computer (not shown), including one or more processors, controllers, and memory, for example. In some examples, memory can have one or more HD maps including a plurality of features stored thereon. In some examples, vehicle 300 can further include a wireless transceiver (not shown). Vehicle 370 can include one or more proximity sensors 372 (e.g., LiDAR, RADAR, and/or ultrasonic sensors) and cameras 374, for example. In some examples, vehicle 370 can further include an onboard computer (not shown) and a wireless transceiver (not shown).

While driving autonomously, vehicle 300 can encounter a second vehicle 370. In some situations, the second vehicle 370 can obscure a nearby object, such as pedestrian 310. Vehicle 300 can detect vehicle 370 using one or more of its proximity sensors 302 and cameras 304, but may not be able to detect pedestrian 310. However, vehicle 370 may be able to detect pedestrian 310 using one or more of its proximity sensors 372 and cameras 374. In some examples, vehicle 370 can wirelessly alert vehicle 300 of pedestrian 310. In response to receiving the notification that pedestrian 310 is nearby, vehicle 300 can perform a maneuver (e.g., slow down, stop, turn, etc.) to avoid a collision. If visibility conditions are poor, a proximity sensor 372 included in vehicle 370 can detect the pedestrian 310 without the camera 374 and notify vehicle 300.

FIG. 3B illustrates an interior view of exemplary vehicle 300 including a representation 320 of pedestrian 310, according to examples of the disclosure. Vehicle 300 can further include an infotainment panel 332 (e.g., an infotainment display), steering wheel 334, and front windshield 336. In response to receiving the notification from vehicle 370 that pedestrian 310 is close to vehicle 300, vehicle 300 can generate a visual representation 320 to alert the passengers that pedestrian 310 is close to the vehicle 300.

Vehicle 300 can generate the visual representation 320 based on the notification from vehicle 370. For example, the notification can include 3D data corresponding to the pedestrian 310. Upon receiving the 3D data, the vehicle 300 can determine an outline of pedestrian 310 from the 3D data. Based on the determined outline, vehicle 300 can determine that the data is indicative of a pedestrian, for example. In some examples, vehicle 370 can create the visual representation 320 and transmit it to vehicle 300. More details on how the visual representation 320 can be produced will be described. In some examples, the visual representation 320 can be displayed on infotainment panel 332 and can be rendered in color. The visual representation 320 can be colored realistically, rendered in a single color indicative of the object type (e.g., non-static, pedestrian, etc.), or rendered with a gradient indicative of object distance, for example. In some examples, a position of visual representation 320 can be indicative of a position of the pedestrian 310 relative to the vehicle 300. For example, when the pedestrian 310 is towards the right of the vehicle 300, visual representation 320 can be displayed in a right half of display 132. In some examples, the position of visual representation 320 can be independent of the position of the pedestrian 310.

FIG. 3C illustrates an interior view of exemplary vehicle 300 including a representation 350 of a pedestrian 310, according to examples of the disclosure. Vehicle 300 can further include an infotainment panel 362, steering wheel 364, and front windshield 366. In response to receiving the notification from vehicle 370 that pedestrian 310 is close to vehicle 300, vehicle 300 can generate a visual representation 350 to alert the passengers that pedestrian 310 is close to the vehicle 300.

Vehicle 300 can generate the visual representation 350 based on the notification from vehicle 370. For example, the notification can include 3D data corresponding to the pedestrian 310. In response to receiving the 3D data, the vehicle 300 can determine an outline of the pedestrian 310 from the 3D data. Based on the determined outline, the vehicle 300 can determine that the data is indicative of a pedestrian, for example. In some examples, vehicle 370 can create the visual representation 350 and transmit it to vehicle 300. More details on how the visual representation 320 can be produced will be described. In some examples, the visual representation 320 can be displayed on a HUD included in windshield 366 and can be rendered in color. The visual representation 350 can be colored realistically, rendered in a single color indicative of the object type (e.g., nonstatic, pedestrian, etc.), or rendered with a gradient indicative of object distance, for example. In some examples, a position of visual representation 350 can be indicative of a position of the pedestrian 310 relative to the vehicle 300. For example, when the pedestrian 310 is towards the right of the vehicle 300, visual representation 320 can be displayed in a right half HUD included in windshield 366. In some examples, the position of visual representation 350 can be independent of the position of the pedestrian 310.

In some examples, visual representation 320 can be displayed on infotainment panel 332 or 362 at a same time that visual representation 360 is displayed on a HUD included in windshield 336 or 366. In some examples, a user can select where they would like visual indications, including visual representations 320 or 350, to be displayed. A sound can be played or a tactile notification can be sent to the passengers while visual representation 320 or 350 is displayed to further alert the passengers, for example. In some examples, text can be displayed with the visual representation 320 or 350 to identify the type of object (e.g., “pedestrian detected”), describe the maneuver the vehicle is performing (e.g., “automatic deceleration”), and/or display other information (e.g., display a distance between vehicle 300 and pedestrian 310, indicate that the pedestrian 310 was detected by a nearby vehicle 370, etc.). In some examples, in response to detecting two or more objects, the vehicle can display two or more visual representations of the detected objects at the same time.

FIG. 3D illustrates an exemplary process 380 for generating a visual representation of an object detected by a second vehicle 370 according to examples of the disclosure. Vehicle 300 can perform process 380 in response to receiving a notification from vehicle 370 that an object (e.g., pedestrian 310) is near or moving towards vehicle 300.

Process 380 can be performed during a partially- or fully-autonomous driving mode of vehicle 300. In some examples, it can be advantageous to perform method 380 when a driver is operating vehicle 300, as they may not be able to see objects obstructed by other vehicles. Similarly, process 380 can be performed during poor visibility conditions or in good visibility conditions, for example.

While driving, vehicle 300 can detect the presence of a second vehicle 370 (step 382 of process 380). For example, one or more of vehicle 300 and vehicle 370 can transmit an identification signal to initiate a wireless communication channel between the two vehicles. Once the wireless communication channel is established, vehicle 300 and vehicle 370 can transmit data, including nearby object data, to each other.

After establishing the wireless communication channel with vehicle 370, vehicle 300 can receive a notification from vehicle 370 indicative of a nearby object (e.g., pedestrian 310) (step 384 of process 380). In some examples, the notification can include one or more of 3D data, a 2D grayscale image, a characterization, and a 2D color image corresponding to the detected object (e.g., pedestrian 310). That is to say, in some examples, the vehicle 370 that detects the object (e.g., pedestrian 310) can do any amount of data processing to produce a visual representation of the detected object.

In response to receiving the notification, vehicle 300 can generate a visual representation of the object (step 286 of process 380). This step can include performing any remaining processing not performed at vehicle 370 according to one or more steps of method 170 for non-static objects and method 270 for static objects. In some examples, vehicle 370 can fully generate the visual representation and transmit it with the notification.

Once the visual representation of the proximate object is fully generated, vehicle 300 can display it (step 388 of process 380). For example, visual representation 320 can be displayed on an infotainment panel 332 and visual representation 350 can be displayed on a HUD included in windshield 366. In some examples, a vehicle can include additional or alternative screens configured to display a visual representation of a nearby object. In some examples, vehicle 300 can produce a second notification, such as a sound or a tactile notification, in addition to displaying the visual representation 320 or 350.

FIG. 4 illustrates an exemplary process 400 for notifying a nearby vehicle of a proximate object. Process 400 can be performed by a vehicle, such as vehicle 370. Although process 400 will be described as being performed by vehicle 370, in some examples, process 400 can be performed by a smart device, such as a smart stop sign, a smart traffic light, a smart utility box, or other device.

Vehicle 370 can detect a nearby vehicle (e.g., vehicle 300) using one or more sensors, such as proximity sensors 372 and/or cameras 374 (step 402 of process 400). In some examples, detecting a nearby vehicle can include establishing a wireless communication channel, as described above with reference to FIG. 3D.

Vehicle 370 can detect a nearby object (e.g., pedestrian 310) using one or more sensors such as proximity sensors 370 and/or cameras 374, for example (step 404 of process 400). Detecting a nearby object can include determining one or more of a size, shape, location, and speed of the object, for example.

In some examples, the vehicle 370 can determine whether a collision between object (e.g., pedestrian 310) and the nearby vehicle (e.g., vehicle 300) is possible (step 406 of process 400). For example, vehicle 370 can determine a speed and trajectory of the vehicle 300 and of the object (e.g., pedestrian 310). If a collision is not possible, that is, the vehicle 300 and pedestrian 310 are sufficiently far from each other or moving away from each other, process 400 can terminate without transmitting a notification to vehicle 300.

If, however, based on the speed and trajectory of vehicle 300 and pedestrian 310, a collision is possible, vehicle 370 can transmit a notification to vehicle 300 (step 410 of process 400). As described above, the notification can include one or more of 3D data, a 2D grayscale image, a characterization, and/or a 2D color image corresponding to the detected object (e.g., pedestrian 310). That is to say, the vehicle 370 that detects the object (e.g., pedestrian 310) can do any amount of data processing to produce a visual representation of the detected object. In response, vehicle 300 can perform any remaining processing steps for generating and displaying the visual representation according to any examples described with reference to FIGS. 1-3.

In some examples, in response to detecting two or more objects, the vehicle can display two or more visual representations of the detected objects at the same time. In some examples, each object of the plurality of objects can be independently detected. For example, a vehicle could encounter a non-static object (e.g., animal 110), a static object (e.g., stop sign 210), and an object blocked by another vehicle (e.g., pedestrian 310) simultaneously. In response to each object, the vehicle can produce each visual representation as appropriate for the object. For example, a visual representation of the animal 110 can be produced based on non-visual 3D data from one or more sensors (e.g., a proximity sensor such as LiDAR, RADAR, an ultrasonic sensor, etc.) while a visual representation of the stop sign 210 can be produced based on data from an HD map. In some examples, a characteristic, such as size, position, and/or color of each visual representation can remain unchanged when concurrently displayed with other visual representations. In some examples, however, one or more of the characteristics of one or more visual representations can change when concurrently displayed with other visual representations. For example, the characteristics of each visual representation can change based on relative speed, size, and/or distance of the object the visual representation symbolizes. Further, in some examples, if more than one object is detected, the visual representations can be prioritized based on a perceived risk presented by each. For example, in a situation where there is pedestrian (e.g., pedestrian 310) crossing the street but the street also has a stop sign (e.g., stop sign 210) few meters behind the pedestrian, a visual representation of the stop sign can be displayed more prominently than a visual representation of the pedestrian. In some examples, two or more visual representations can be distinguished based on size, color, or some other visual characteristic. In some examples, displaying the two or more visual representations at a same time can prevent possibly confusing the user by displaying each visual representation in succession.

In some examples, an electronic control unit (ECU) can fuse information received from multiple sensors (e.g., a LiDAR, radar, GNSS device, camera, etc.) prior to displaying the two or more visual representations of the detected objects. Such fusion can be performed at one or more of a plurality of ECUs. The particular ECU(s) at which the fusion is performed can be based on an amount of resources (e.g., memory and/or processing power) available to a particular ECU.

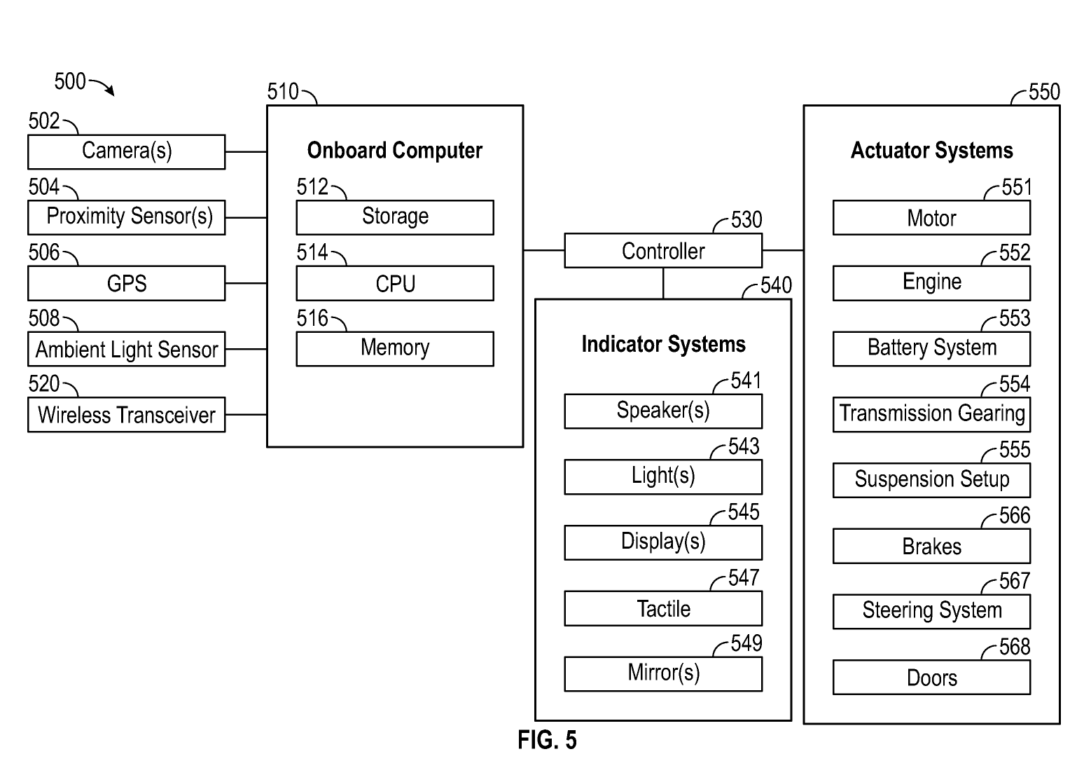

FIG. 5 illustrates a block diagram of a vehicle 500 according to examples of the disclosure. In some examples, vehicle 500 can include one or more cameras 502, one or more proximity sensors 504 (e.g., LiDAR, radar, ultrasonic sensors, etc.), GPS 506, and ambient light sensor 508. These systems can be used to detect a proximate object, detect a proximate vehicle, and/or detect poor visibility conditions, for example. In some examples, vehicle 500 can further include wireless transceiver 520. Wireless transceiver can be used to communicate with a nearby vehicle or smart device according to the examples described above, for example. In some examples, wireless transceiver can be used to download one or more HD maps from one or more servers (not shown).

In some examples, vehicle 500 can further include onboard computer 510, configured for controlling one or more systems of the vehicle 500 and executing any of the methods described with reference to FIGS. 1-4 above. Onboard computer 510 can receive inputs from cameras 502, sensors 504, GPS 506, ambient light sensor 508, and/or wireless transceiver 520. In some examples, onboard computer 510 can include storage 512, processor 514, and memory 516. In some examples, storage 512 can store one or more HD maps and/or object characterization data.

Vehicle 500 can include, in some examples, a controller 530 operatively coupled to onboard computer 510, to one or more actuator systems 550, and/or to one or more indicator systems 540. In some examples, actuator systems 550 can include a motor 551 or engine 552, a battery system 553, transmission gearing 554, suspension setup 555, brakes 566, steering system 567, and doors 568. Any one or more actuator systems 550 can be controlled autonomously by controller 530 in an autonomous driving mode of vehicle 500. In some examples, onboard computer 510 can control actuator systems 550, via controller 530, to avoid colliding with one or more objects, as described above with reference to FIGS. 1-4.

In some examples, controller 530 can be operatively coupled to one or more indicator systems 540, such as speaker(s) 541, light(s) 543, display(s) 545 (e.g., an infotainment display such as display 132, 162, 232, 262, 332, or 362 or a HUD included in windshield 136, 166, 236, 266, 336, or 366), tactile indicator 547, and mirror(s) 549. In some examples, one or more displays 545 (and/or one or more displays included in one or more mirrors 549) can display a visual representation of a nearby object, as described above with reference to FIGS. 1-4. One or more additional indications can be concurrently activated while the visual representation is displayed. Other systems and functions are possible.

Therefore, according to the above, some examples of the disclosure relate to a vehicle, comprising one or more sensors configured to sample non-visual three-dimensional (3D) data, a processor configured to characterize a first object near the vehicle based on one or more of the 3D data and data included in one or more HD maps stored on a memory of the vehicle, and generate a two-dimensional (2D) visual representation of the first object, and a display configured to display the 2D visual representation of the first object. Additionally or alternatively to one or more of the examples disclosed above, the processor is further configured to generate a 3D representation of the first object. Additionally or alternatively to one or more of the examples disclosed above, generating the 2D visual representation includes generating a grayscale 2D representation of the non-visual 3D data. Additionally or alternatively to one or more of the examples disclosed above, generating the 2D visual representation includes colorizing the grayscale 2D representation of the non-visual 3D data based on one or more of a determined shape of the first object and a characterization of the first object. Additionally or alternatively to one or more of the examples disclosed above, a colorization of the 2D visual representation is one or more of based on a realistic coloring of the first object, color-coded based on the characterization of the first object, and indicative of a distance between the vehicle and the first object. Additionally or alternatively to one or more of the examples disclosed above, the vehicle further comprises a speaker configured to play a sound at a same time as displaying the 2D visual representation. Additionally or alternatively to one or more of the examples disclosed above, the processor is further configured to determine whether the first object corresponds to a feature of the plurality of features included in the one or more HD maps, in accordance with a determination that the first object corresponds to a feature of the plurality of features included in the one or more HD maps, generating the 2D visual representation based on the corresponding feature in the one or more HD maps, and in accordance with a determination that the first object does not correspond to a feature of the plurality of features included in the one or more HD maps, generating the 2D visual representation based on the non-visual 3D data. Additionally or alternatively to one or more of the examples disclosed above, the vehicle further comprises a wireless transceiver is configured to receive a notification corresponding to a second object, the notification including one or more of 3D data, a 2D grayscale image, and a 2D color image corresponding to the second object. Additionally or alternatively to one or more of the examples disclosed above, the processor is further configured to generate a 2D visual representation of the second object based on the received notification, and the display is further configured to display the 2D visual representation of the second object. Additionally or alternatively to one or more of the examples disclosed above, the vehicle further comprises a wireless transceiver configured to transmit, to a second vehicle, a notification corresponding to the first object, the notification including one or more of non-visual 3D data, a 2D grayscale image, and a 2D color image corresponding to the first object. Additionally or alternatively to one or more of the examples disclosed above, the processor is further configured to determine a poor visibility condition based on data from one or more of a camera and an ambient light sensor, and generating the 2D visual representation of the first object occurs in response to determining the poor visibility condition. Additionally or alternatively to one or more of the examples disclosed above, the one or more sensors are LiDAR, radar, or ultrasonic sensors. Additionally or alternatively to one or more of the examples disclosed above, the object is not visible to the vehicle.

Some examples of the disclosure are directed to a method performed at a vehicle, the method comprising sampling, with one or more sensors of the vehicle, non-visual three-dimensional (3D) data, characterizing, with a processor included in the vehicle, a first object near the vehicle based on one or more of the 3D data and data included in one or more HD maps stored on a memory of the vehicle, generating, with the processor, a two-dimensional (2D) visual representation of the first object, and displaying, at a display of the vehicle, the 2D visual representation of the first object.

Some examples of the disclosure are related to a non-transitory computer-readable medium including instructions, which when executed by one or more processors, cause the one or more processors to perform a method at a vehicle, the method comprising, sampling, with one or more proximity sensors of the vehicle, three-dimensional (3D) data, characterizing, with the one or more processors, a first object near the vehicle based on one or more of the 3D data and data included in one or more HD maps stored on a memory of the vehicle, generating, with the one or more processors, a two-dimensional (2D) visual representation of the first object, and displaying, at a display of the vehicle, the 2D visual representation of the first object.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. A vehicle, comprising:
one or more sensors configured to sample non-visual three-dimensional (3D) data;
a processor configured to:
characterize a first object near the vehicle based on one or more of the 3D data and data included in one or more HD maps stored on a memory of the vehicle; and
generate a two-dimensional (2D) visual representation of the first object; and
a display configured to display the 2D visual representation of the first object.

2. The vehicle of claim 1, wherein the processor is further configured to generate a 3D representation of the first object.

3. The vehicle of claim 2, wherein generating the 2D visual representation includes generating a grayscale 2D representation of the non-visual 3D data.

4. The vehicle of claim 3, wherein generating the 2D visual representation includes colorizing the grayscale 2D representation of the non-visual 3D data based on one or more of a determined shape of the first object and a characterization of the first object.

5. The vehicle of claim 1, wherein a colorization of the 2D visual representation is one or more of based on a realistic coloring of the first object, color-coded based on the characterization of the first object, and indicative of a distance between the vehicle and the first object.

6. The vehicle of claim 1, further comprising a speaker configured to play a sound at a same time as displaying the 2D visual representation.

7. The vehicle of claim 1, wherein the processor is further configured to:
determine whether the first object corresponds to a feature of the plurality of features included in the one or more HD maps;
in accordance with a determination that the first object corresponds to a feature of the plurality of features included in the one or more HD maps, generating the 2D visual representation based on the corresponding feature in the one or more HD maps; and
in accordance with a determination that the first object does not correspond to a feature of the plurality of features included in the one or more HD maps, generating the 2D visual representation based on the non-visual 3D data.

8. The vehicle of claim 1, further comprising:
a wireless transceiver is configured to receive a notification corresponding to a second object, the notification including one or more of 3D data, a 2D grayscale image, and a 2D color image corresponding to the second object.

9. The vehicle of claim 8, wherein:
the processor is further configured to generate a 2D visual representation of the second object based on the received notification, and
the display is further configured to display the 2D visual representation of the second object.

10. The vehicle of claim 1, further comprising:
a wireless transceiver configured to transmit, to a second vehicle, a notification corresponding to the first object, the notification including one or more of non-visual 3D data, a 2D grayscale image, and a 2D color image corresponding to the first object.

11. The vehicle of claim 1, wherein the processor is further configured to determine a poor visibility condition based on data from one or more of a camera and an ambient light sensor, and generating the 2D visual representation of the first object occurs in response to determining the poor visibility condition.

12. The vehicle of claim 1, wherein the one or more sensors are LiDAR, radar, or ultrasonic sensors.

13. The vehicle of claim 1, wherein the object is not visible to the vehicle.

14. A method performed at a vehicle, the method comprising:
sampling, with one or more sensors of the vehicle, non-visual three-dimensional (3D) data;
characterizing, with a processor included in the vehicle, a first object near the vehicle based on one or more of the 3D data and data included in one or more HD maps stored on a memory of the vehicle;
generating, with the processor, a two-dimensional (2D) visual representation of the first object; and
displaying, at a display of the vehicle, the 2D visual representation of the first object.

15. A non-transitory computer-readable medium including instructions, which when executed by one or more processors, cause the one or more processors to perform a method at a vehicle, the method comprising:
sampling, with one or more proximity sensors of the vehicle, three-dimensional (3D) data;
characterizing, with the one or more processors, a first object near the vehicle based on one or more of the 3D data and data included in one or more HD maps stored on a memory of the vehicle;
generating, with the one or more processors, a two-dimensional (2D) visual representation of the first object; and
displaying, at a display of the vehicle, the 2D visual representation of the first object.
